(19) United States
(12) Patent Application Publication
(10) Pub. No.: US 2013/0051745 A1
(43) Pub. Date: Feb. 28, 2013

(54) Plenum-Rated Optical Cables Utilizing Yarn Coated With Flame-Retarding and Smoke-Suppressing Coating

(71) Applicant: Peter A. Weimann, Atlanta, GA (US)

(72) Inventor: Peter A. Weimann, Atlanta, GA (US)

(21) Appl. No.: 13/221,080

(22) Filed: Aug. 30, 2011

(51) Int. Cl. G02B 6/44

(52) U.S. Cl. 385/112; 385/100; 385/114; 385/109

(57) ABSTRACT

Certain embodiments of the invention may include a plenum-rated optical fiber cables utilizing yarn coated with a flame-retarding and smoke-suppressing. According to an example embodiment of the invention, a plenum-rated optical fiber cable is provided. The plenum-rated optical fiber cable includes an optical fiber, a jacket surrounding the optical fiber, and a layer of yarn positioned between the optical fiber and the jacket. The jacket is made from a low-smoke polymer, the yarn is coated with a sufficient amount of flame-retarding and smoke-suppressing material such that the cable passes the NFPA 262 “Steiner Tunnel” fire test, whereby its flame spread is less than 5 feet, peak optical density is less than 0.50, and average optical density is less than 0.15.

### TECHNICAL FIELD

This invention generally relates to cables having superior resistance to flame spread and smoke evolution, and more particularly, to cables suitable for building plenums because of the superior resistance to flame spread and smoke evolution.

### BACKGROUND OF THE INVENTION

Fire safety of optical cables utilized in indoor spaces in the United States is specified by the National Electric Code (NEC) as the NFPA 70 standard, and is published by the National Fire Protection Association (NEPA). For optical cables, the highest level of flame-retardancy recognized by the NEC is the so-called “plenum” rating, and such rating is given to cables that passed the demanding NFPA 262 “Steiner Tunnel” Fire test.

An example of a basic plenum-rated buffered optical fiber is disclosed in U.S. Pat. No. 6,298,188 ('188 reference) to Chapin et al. An exemplary plenum-rated buffered optical fiber in '188 reference comprises a core, a cladding surrounding the core, one or more coatings surrounding the cladding, and a buffer surrounding the coating. One or more of the plenum-rated buffered optical fibers are further surrounded by strength members such as stress rods and yarn, and a jacket such as low smoke polymer to form a plenum-rated optical fiber cable. Other cable configurations and/or cable structures of plenum-rated optical fiber cables are disclosed in U.S. Pat. No. 4,319,940 to Arroyo et al., U.S. Pat. No. 4,595,793 to Arroyo et al., U.S. Pat. No. 5,857,051 to Travicso et al., and U.S. Pat. No. 6,122,424 to Bringuier.

Plenum optical cables are often used in schools, hospitals, office buildings and other environment where the risk of significant flame spread and/or smoke emission is a threat to human life and health. Plenum cables are also increasingly used in data centers, supercomputer centers, storage area networks and other ‘mission critical’ applications where the highest level of fire safety is required.

As bandwidth demands go up, end users desire reductions in the size of optical cables used in various applications including applications where plenum-rated optical fiber cables are required.

### BRIEF SUMMARY OF THE INVENTION

Therefore, an objective of the present invention is to provide small plenum optical fiber cables, which have high optical fiber packing density and pass the NFPA 262 “Steiner Tunnel” fire test. According to one embodiment of the present invention, a flame- and smoke-retardant optical fiber cable is provided. The cable includes an optical fiber, a jacket surrounding the optical fiber, and a layer of yarn positioned between the optical fiber and the jacket. The jacket is made from a low-smoke polymer. The yarn is coated with a sufficient amount of flame-retarding and smoke-suppressing material such that the cable passes the NFPA 262 “Steiner Tunnel” fire test, whereby its flame spread is less than 5 feet, peak optical density is less than 0.50, and average optical density is less than 0.15.

According to another embodiment of the present invention, another flame- and smoke-retardant optical fiber cable is provided. The cable includes an optical fiber, a jacket surrounding the optical fiber, and a layer of yarn positioned between the optical fiber and the jacket. The jacket is made from a low-smoke polymer. The yarn is coated with a sufficient amount of flame-retarding and smoke-suppressing material such that the total smoke of the layer of yarn is less than 100 according to cone calorimetry test.

### BRIEF DESCRIPTION OF THE DRAWINGS

Reference will now be made to the accompanying figures and flow diagrams, which are not necessarily drawn to scale, and wherein:

FIG. 1 is a diagram of an illustrative flame- and smoke-retardant optical fiber cable according to an example embodiment of the present invention;

FIG. 2 is a chart of heat release rate (HRR) from sample yarn;

FIG. 3 is a chart of smoke from sample yarn;

FIG. 4 is a diagram of another illustrative flame- and smoke-retardant optical fiber cable according to an example embodiment of the present invention;

FIG. 5 is a diagram of another illustrative flame- and smoke-retardant optical fiber cable according to an example embodiment of the present invention;

FIG. 6 is a diagram of another illustrative flame- and smoke-retardant optical fiber cable according to an example embodiment of the present invention;

FIG. 7 is a diagram of another illustrative flame- and smoke-retardant optical fiber cable according to an example embodiment of the present invention;

FIG. 8 is a diagram of another illustrative flame- and smoke-retardant optical fiber cable according to an example embodiment of the present invention;

FIG. 9 is a diagram of another illustrative flame- and smoke-retardant optical fiber cable according to an example embodiment of the present invention;

FIG. 10 is a diagram of another illustrative flame- and smoke-retardant optical fiber cable according to an example embodiment of the present invention;

FIG. 11 is a diagram of another illustrative flame- and smoke-retardant optical fiber cable according to an example embodiment of the present invention;

FIG. 12 is a diagram of another illustrative flame- and smoke-retardant optical fiber cable according to an example embodiment of the present invention;

FIG. 13 is a diagram of another illustrative flame- and smoke-retardant optical fiber cable according to an example embodiment of the present invention;

FIG. 14 is a diagram of another illustrative flame- and smoke-retardant optical fiber cable according to an example embodiment of the present invention;

FIG. 15 is a diagram of another illustrative flame- and smoke-retardant optical fiber cable according to an example embodiment of the present invention;

FIG. 16 is a diagram of another illustrative flame- and smoke-retardant optical fiber cable according to an example embodiment of the present invention;

FIG. 17 is a diagram of another illustrative flame- and smoke-retardant optical fiber cable according to an example embodiment of the present invention;

FIG. 18 is a diagram of a yarn bundle according to an example embodiment of the present invention; and

FIG. 19 is a diagram of an illustrative flame- and smoke-retardant optical fiber cable from its side according to an example embodiment of the present invention.

### DETAILED DESCRIPTION

In the following description, similar components are referred to by the same reference numeral to enhance the understanding of the invention through the description of the drawings. Also, unless otherwise explicitly specified herein, the drawings are not drawn to scale.

Although specific features, configurations and arrangements are discussed herein below, it should be understood that such is done for illustrative purposes only. A person skilled in the relevant art will recognize that other steps, configurations and arrangements are useful without departing from the spirit and scope of the invention. Relevant accepted tensile ratings for indoor optical cables are disclosed in the Telcordia GR-409 and ICEA-S-83-596-2001 standards.

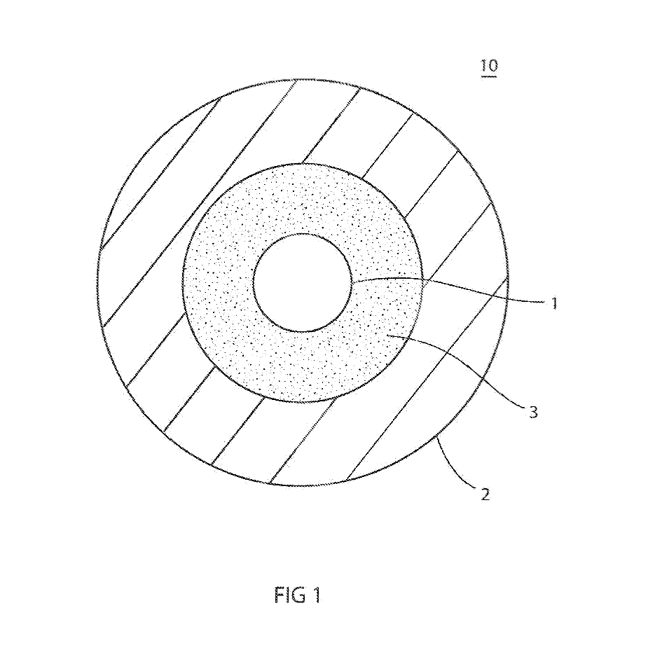

Referring to FIG. 1, a plenum-rated optical fiber cable 10 according to one embodiment of the invention is shown. The plenum-rated optical fiber cable 10 is a flame- and smoke-retardant optical fiber cable. The plenum-rated optical fiber cable 10 includes an optical fiber 1, a jacket 2 surrounding the optical fiber 1, and a layer of yarn 3 positioned between the optical fiber 1 and the jacket 2. The optical fiber 1 may be multiple optical fibers 1. The optical fiber 1 may be buffered or unbuffered. When the optical fiber 1 is buffered, a plenum-grade compound such as a low-smoke PVC or fluoropolymer is used as a buffer to limit burning and smoke emission of acrylate optical fiber coating(s). A low-smoke polymer is suitable for the jacket 2. For example, a low smoke PVC or a fluoropolymer such as a polyvinylidene fluoride (PVDF) copolymer may be used as a jacket material. Sufficient amount of the yarn 3 is positioned between the optical fiber 1 and the jacket 2 such that the cable 10 satisfies required tensile strength for its application. The required tensile strength is different for different application of the cable 10, and it may depend on factors such as cable configuration, cable specification, type of optical fibers, and number of the optical fibers within the cable. The yarn 3 is coated with a sufficient amount of flame-retarding and smoke-suppressing material such that the cable 10 passes the NFPA 262 “Steiner Tunnel” fire test.

In order to pass the NFPA 262 test, a cable must exhibit flame spread of less than 5 feet, and must exhibit very low smoke emission, as measured by “optical density” of a light signal passing through the chamber. Peak smoke density must be less than 0.5, and average smoke density must be less than 0.15. Optical cables passing this test which contain metallic elements are called as Type OFCP (Optical Fiber Conductive Plenum), while dielectric cables passing the test are called as Type OFNP (Optical Fiber Non-conductive Plenum).

Usually, plenum fire performance is achieved through use of an appropriately-selected flame retardant resin, generally low-smoke PVC compounds, fluoropolymers, or fluoropolymer compounds as a buffer for an optical fiber inside a cable. These materials have high flame resistance and low smoke emission, and generally high insulating and dielectric properties. On the other hand, the acrylate primary and secondary coatings used to protect a bare optical fiber burn rapidly, and emit relatively large amount of smoke while burning. Typically, designers of plenum-rated optical cables compensate such easy-to-burn characteristics of a coated optical fiber by insulating the coated optical fiber with a “tight buffer” of a plenum-grade compound such as a low-smoke PVC or fluoropolymer, which limits burning and smoke emission of the acrylate optical fiber coatings. Common diameters for tight buffered optical fibers include 900 microns, 600 microns and 500 microns.

However, as bandwidth demands go up, end users desire size reductions of plenum-rated optical fiber cables used in places such as central switching offices, data centers, storage area networks, supercomputing, or imaging applications. Smaller cable with the same number of optical fibers in the cable provides higher fiber packing density. If the fiber packing density of cables is increased, end-users can make better use of existing infrastructure such as overhead cable racks or under-floor cable trays. Smaller cables will also help with air flow and cooling in crowded facilities. And, it will be possible to terminate a higher density of small cables in shelves and on faceplates.

An obvious way to increase fiber packing density of plenum-rated cables is to eliminate the use of tight buffers for the fibers. Colored 250 micron fibers occupy far less space than 900 micron or even 600 micron tight buffers. However this creates a problem in terms of passing the NFPA 262 “Steiner Tunnel” fire test. The acrylate coatings of the unbuffered optical fiber are free to burn and/or smolder, and emit smoke.

In order to make a small plenum-rated cable, the inventor of the present invention used a layer of yarn coated with a sufficient amount of a flame-retarding and smoke-suppressing material. The flame-retarding and smoke-suppressing material used in the present invention has intumescent properties such that the coating material creates an expanding char on the coated yarn surface to suppress both flame and smoke when subjected to high heat. For example, K 1420/1765, which is commercially available from Fiber-Line, Inc. Hatfield, Pa., is yarn coated with a suitable flame-retarding and smoke-suppressing coating material.

Referring back to FIG. 1, it is not necessary to coat all of the yarn 3 positioned between the optical fiber 1 and the jacket 2 with a flame-retarding and smoke-suppressing coating material. Only portions of the yarn 3 may he coated with the flame-retarding and smoke-suppressing material as long as the resulting cable 10 passes the NFPA 262 “Steiner Tunnel” fire test. For example, the flame-retarding and smoke-suppressing coating covers at least 50% of the yarn 3; preferably, at least 80% of the yarn 3; most preferably, at least 90% of the yarn 3.

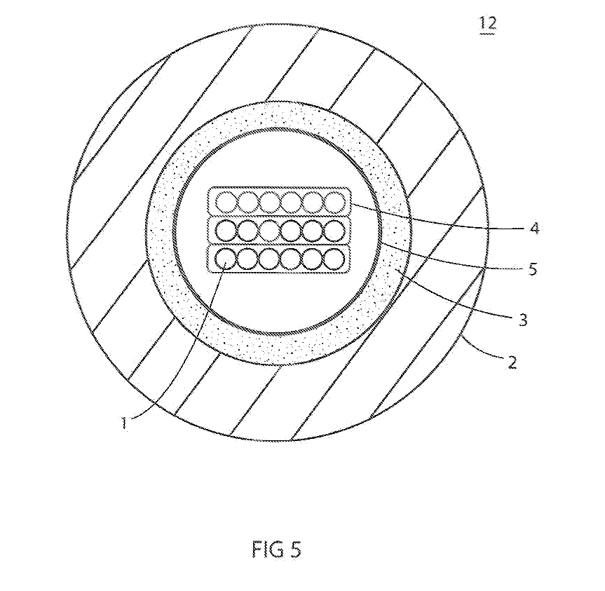

Table 1 below shows comparison among various types of optical fiber cables. All cables other than the last four used standard aramid yarn. The last four cables are according to one embodiment of the invention. The last four cables use K 1420/1765 manufactured by Fiber-Line Inc., which is yarn coated with a suitable flame-retarding and smoke-suppressing material. The cable structure of the sample cables on Table I is similar to the cable in FIG. 5, which is explained in detail later. In order to be considered as passing, two different samples must meet all of the following criteria: flame spread of shorter than 5 feet; peak optical density of less than 0.50; and average optical density of less than 0.15.

Smoke emission is expressed in terms of “optical density” (OD) under the NFPA 262 “Steiner Tunnel” fire test. Optical density of smoke is calculated by the light obscuration using natural density filters, and optical density is calculated as follows:

$$O D = {log}_{10} \frac{{I}_{0}}{I}$$

Where OD is optical density, I₀ is clear beam photo detector signal, and I is photo detector signal with the natural density filter. OD is one type of measurement to determine how much light emitted from a photodiode is scattered or obscured due to the presence of smoke.

| | | | | Flame | | | |
|---|---|---|---|---|---|---|---|
| | Fiber | | | Spread, | Peak | Avg. | Test |
| Sample | Count | Core Construction | Jacket Construction | Feet | OD | OD | result |
| 1 | 72 | 6.1 mm OD, 0.5 mm thick, | 9.4 mm OD, Teknor Apex | 6 | 1.05 | 0.3 | Fail |
| | | SOLEF 32008/0009 | 910 FOB L16 C1A PVC | | | | |
| | | PVDF | jacket, two 0.7 mm linear | | | | |
| | | | rods | | | | |
| 2 | 24 | 6.1 mm OD, 0.5 mm thick, | 9.4 mm OD, AlphaGary | 1 | 0.27 | 0.16 | Fail |
| | | SOLEF 32008/0009 | SGIV 1320 PVC jacket, two | | | | |
| | | PVDF | 0.7 mm linear rods | | | | |
| 3 | 24 | 6.1 mm OD, 0.5 mm thick, | 9.4 mm OD, AlphaGary | 1 | 0.28 | 0.16 | Fail |
| | | SOLEF 32008/0009 | SGIV 1320 PVC jacket, two | | | | |
| | | PVDF | 0.7 mm linear rods | | | | |
| 4 | 96 | 6.8 mm OD, 0.5 mm thick, | 10.2 mm OD, AlphaGary | 1.5 | 0.33 | 0.19 | Fail |
| | | SOLEF 32008/0009 | SGIV 1320 PVC jacket, two | | | | |
| | | PVDF | 0.7 mm linear rods | | | | |
| 5 | 12 | 6.1 mm OD, 0.5 mm thick, | 9.4 mm OD, AlphaGary | 1.5 | 0.27 | 0.15 | Fail |
| | | SOLEF 32008/0009 | SGIV 1320 PVC jacket, two | | | | |
| | | PVDF | 0.5 mm linear rods | | | | |
| 6 | 12 | 6.1 mm OD, 0.5 mm thick, | 9.4 mm OD, AlphaGary | 1.5 | 0.33 | 0.17 | Fail |
| | | SOLEF 32008/0009 | SGIV 1320 PVC jacket, two | | | | |
| | | PVDF | 0.5 mm linear rods | | | | |
| 7 | 72 | 6.1 mm OD, 0.5 mm thick, | 9.4 mm OD, AlphaGary | 3 | 0.35 | 0.2 | Fail |
| | | SOLEF 32008/0009 | SGIV 1320 PVC jacket, two | | | | |
| | | PVDF | 0.5 mm linear rods | | | | |
| 8 | 24 | 6.1 mm OD, 0.5 mm thick, | 9.8 mm OD, AlphaGary | 2.5 | 0.33 | 0.18 | Fail |
| | | SOLEF 32008/0009 | SGIV 1320 PVC jacket, two | | | | |
| | | PVDF | 0.5 mm linear rods jacketed | | | | |
| | | | to 1.0 mm with 32008/0009 | | | | |
| | | | PVDF | | | | |
| 9 | 72 | 6.1 mm OD, 0.5 mm thick, | 9.8 mm OD, AlphaGary | 3 | 0.34 | 0.19 | Fail |
| | | SOLEF 32008/0009 | SGIV 1320 PVC jacket, two | | | | |
| | | PVDF | 0.5 mm linear rods jacketed | | | | |
| | | | to 1.0 mm with 32008/0009 | | | | |
| | | | PVDF | | | | |
| 10 | 12 | 6.1 mm OD, 0.5 mm thick, | 9.4 mm OD, AlphaGary | 1 | 0.4 | 0.23 | Fail |
| | | SOLEF 32008/0009 | SGIV 1320 PVC jacket, two | | | | |
| | | PVDF | 0.7 mm linear rods, | | | | |
| | | | alternate extrusion method | | | | |
| 11 | 72 | 6.1 mm OD, 0.5 mm thick, | 9.4 mm OD, AlphaGary | 2 | 0.48 | 0.27 | Fail |
| | | SOLEF 32008/0009 | SGIV 1320 PVC jacket, two | | | | |
| | | PVDF | 0.7 mm linear rods, | | | | |
| | | | alternate extrusion method | | | | |
| 12 | 12 | 6.1 mm OD, 0.45 mm | 9.1 mm OD, AlphaGary | 2 | 0.24 | 0.11 | Pass |
| | | thick, AlphaGary SGIV | SGIV 1320 PVC jacket, two | | | | |
| | | 1320 PVC | 0.7 mm linear rods, | | | | |
| | | | Fiber-Line K1420/1765 | | | | |
| | | | smoke-suppressed FR | | | | |
| | | | aramid yarn | | | | |
| 13 | 12 | 6.1 mm OD, 0.45 mm | 9.1 mm OD, AlphaGary | 1.5 | 0.25 | 0.1 | Pass |
| | | thick, AlphaGary SGIV | SGIV 1320 PVC jacket, two | | | | |
| | | 1320 PVC | 0.7 mm linear rods, | | | | |
| | | | Fiber-Line K1420/1765 | | | | |
| | | | smoke-suppressed FR | | | | |
| | | | aramid yarn | | | | |
| 14 | 96 | 6.8 mm OD, 0.5 mm thick, | 9.8 mm OD, AlphaGary | 2 | 0.36 | 0.14 | Pass |
| | | AlphaGary SGIV 1320 | SGIV 1320 PVC jacket, two | | | | |
| | | PVC | 0.7 mm linear rods, | | | | |
| | | | Fiber-Line K1420/1765 | | | | |
| | | | smoke-suppressed FR | | | | |
| | | | aramid yarn | | | | |
| 15 | 96 | 6.8 mm OD, 0.5 mm thick, | 9.8 mm OD, AlphaGary | 2.5 | 0.38 | 0.15 | Pass |
| | | AlphaGary SGIV 1320 | SGIV 1320 PVC jacket, two | | | | |
| | | PVC | 0.7 mm linear rods, | | | | |
| | | | Fiber-Line K1420/1765 | | | | |
| | | | smoke-suppressed FR | | | | |
| | | | aramid yarn | | | | |

As shown in Table I above, because cable samples 1 to 11 use unbuffered optical fibers for ribbon fibers and standard aramid yarn, cable samples 1 to 11 failed to meet the NFPA 262 “Steiner Tunnel” fire test. Excessive smoke is generated from the acrylate coatings on the unbuffered optical fibers. However, the last four cables, which are according to one embodiment of the invention passed the NFPA 262 “Steiner Tunnel” fire test despite of unbuffered optical fibers in the cables. All of the cables passed the NFPA 262 “Steiner funnel” fire test include yarn coated with the flame-retarding and smoke-suppressing material.

The yarn used in the present invention is preferably aramid yarn. Aramid yarn does not burn; it instead depolymerizes and sublimes. Its light weight, high strength and inherent resistance to flame are ideal for indoor cables. In addition, use of aramid yarn helps termination of the cable. A connector can be “crimped” to the aramid yarn, which allows the yarn to reinforce the connector and prevent users from accidentally pulling the connector off the terminated end of the cable. Despite these benefits, the aramid yarn emits smoke. However, a flame-retarding and smoke-suppressing coating on the yarn substantially reduces smoke emission from the yarn.

Table II below shows comparison among various types of yarn under cone calorimetry test. The test was performed on a cone calorimeter manufactured by Fire Test Technology, Ltd, in East Grinstead, UK. All yarns other than the last one are uncoated aramid yarns. The last one is the yarn used in one embodiment of the invention, which arc coated with a flame-retarding and smoke-suppressing material. Each value is based on two different samples of each type of yarn.

| | | | | Peak | Mean | Total | | |
|---|---|---|---|---|---|---|---|---|
| Sample | | Peak | Total | HRR, | HRR, | HRR, | Maximum Flame | Ignition |
| number | Material name | smoke | smoke | kW/m² | kW/m² | MJ/m² | Temperature, ° C. | Time, s |
| A | Kolon/Heracron | 0.021 | 451 | 91 | 54 | 23.4 | 514 | 47 |
| | Yarn HF300 | | | | | | | |
| B | Teijin/Twaron | 0.032 | 570 | 106 | 59 | 25 | 538 | 37 |
| | D2200 | | | | | | | |
| C | DuPont/Kevlar 49 | 0.02 | 360 | 80 | 47 | 24.4 | 501 | 143 |
| D | Fiber-Line/XX49 | 0.009 | 87 | 47 | 22 | 7.8 | 432 | 197 |
| | 76-C | | | | | | | |

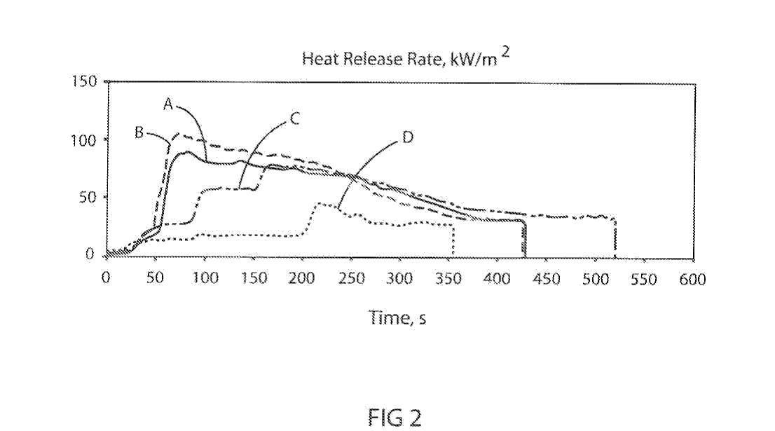

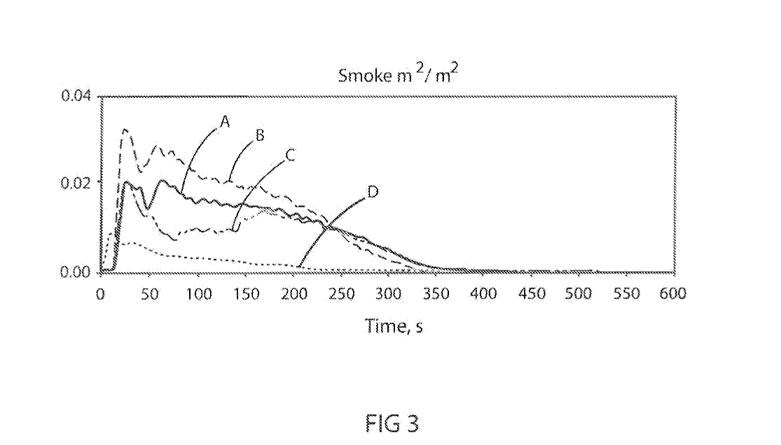

FIG. 2 shows heat release rate (HRR) in kW/m² of each sample by sample number. Also, FIG. 3 shows smoke in m²/m² (i.e. unit less) of each sample by sample number.

The cone calorimetry smoke data plotted in FIG. 3 is “extinction coefficient” which is calculated using the following equation:

$$k = \frac{K}{L} ln ( \frac{{I}_{0}}{I} )$$

Where k is extinction coefficient, K is the optical density correction factor, l₀ is normalized signal from compensating photodiode, l is normalized signal from main photodiode and L is the path length (0.114 in). Extinction coefficient is one type of measurement to determine how much light emitted from a photodiode is scattered or obscured due to the presence of smoke.

As it is shown in Table II and FIG. 2; Sample number D, which is the yarn coated with the flame-retarding and smoke-suppressing coating exhibits lowest peak and mean HRR among the all samples tested. Also, as it is shown in Table II and FIG. 3, Sample number D exhibits lowest peak and mean smoke among the all samples tested. Accordingly, Table II and corresponding figures show that the flame-retarding and smoke-suppressing coating material on the yarn according to the present invention substantially reduces smoke emission from the yarn.

If yarn is coated with the flame-retarding and smoke-suppressing material, a plenum-rated cable using such yarn may support unbuffered optical fibers. Because the use of tight buffers for the fibers in plenum-rated cables can be eliminated, 250 micron fibers may be used rather than 900 micron or even 600 micron tight buffer fibers. Therefore, a plenum-rated cable with unbuffered optical fibers increases fiber packing density of the cable and reduces the overall size of the cable. For example, a plenum-rated optical fiber cable according to one embodiment of the present invention has a cable nominal diameter of less than 10 mm for the cable having 72 fibers or less, and a cable nominal diameter of less than 11 mm for the cable having 96 fibers or less.

Also, limited smoke emission from the yarn provides the design freedom to utilize cheaper jacketing materials. Depending on the cable configuration and materials used for other cable components, jacketing material may be replaced from fluoropolymer to low-smoke PVC, or from an expensive low-smoke PVC to a cheaper low-smoke PVC. In addition, depending on the cable configuration and materials used for other cable components, less expensive fibers with smoke-suppressing coatings may be used.

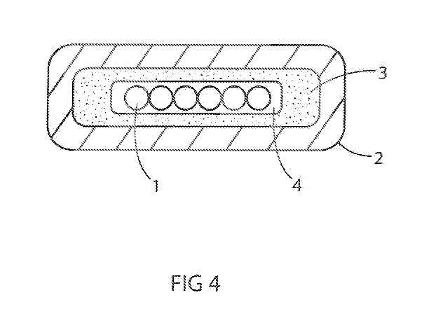

Referring to FIG. 4, a plenum-rated optical fiber cable according to another embodiment of the invention is shown. The plenum-rated optical fiber cable includes an optical fiber ribbon 4, the jacket 2 surrounding the optical fiber ribbon 4, and the layer of yarn 3 positioned between the optical fiber ribbon 4 and the jacket 2. A plurality of the optical fibers 1 are bound together to form the planar optical fiber ribbon 4. In this embodiment, only one optical fiber ribbon 4 with six optical fibers 1 is shown. However, the number of optical fibers in an optical fiber ribbon may vary, and it depends on factors such as cable configuration, cable specification, the dimensions of the fiber ribbons, and application of the cable.

Referring to FIG. 5, a plenum-rated optical fiber cable 12 according to another embodiment of the invention is shown. The plenum-rated optical fiber cable 12 includes the optical fiber ribbons 4, a tube 5 surrounding the optical fiber ribbons 4, the jacket 2 surrounding the tube 5, and the layer of yarn 3 positioned between the tube 5 and the jacket 2. A plurality of the optical fiber ribbons 4 stack on top of each other in the tube 5. In this embodiment, only three optical fiber ribbons 4 with six optical fibers 1 in each ribbon are stacked on top of each other in the tube 5. However, the number of optical fibers in an optical fiber ribbon and number of ribbon in the tube may vary, and those depend on factors such as cable configuration, cable specification, the dimensions of the fiber ribbons, the dimensions of the tube and application of the cable. For example, optical fiber ribbons may be arranged as follows: a 12-fiber stack formed by a 3×4 array of optical fibers (i.e., 3 ribbons having 4 fibers per ribbon) or a 144-fiber stack formed by a 12×12 array optical fibers (i.e., 12 ribbons having 12 fibers per ribbon). The tube 5 can be any suitable material. For example a low-smoke polymer such as a low smoke PVC or a fluoropolymer may be used as a tube material.

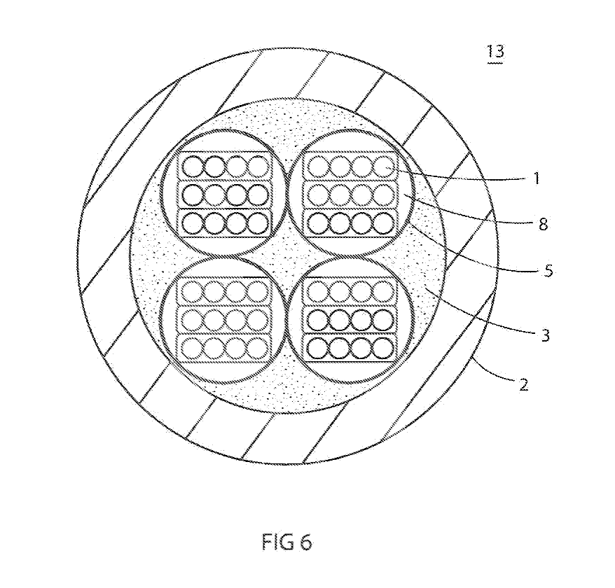

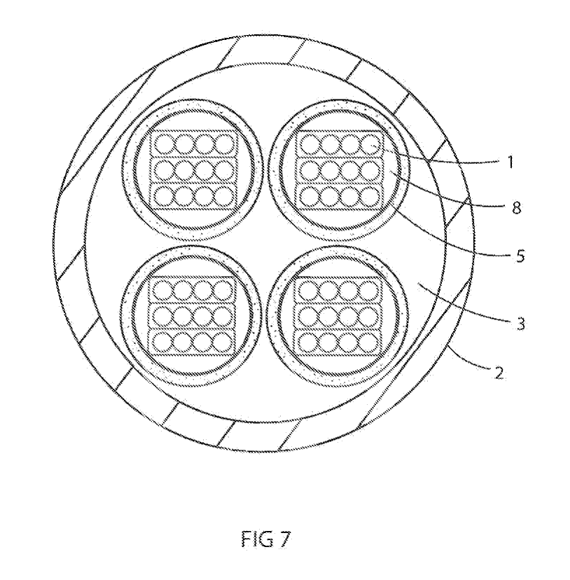

Plurality of optical fiber ribbons 4 may be positioned within multiple tubes 5. Referring to FIG. 6, for example, in a 48-fiber cable 13, each of the four 3×4 array 8 of optical fibers 1 (i.e. 3 ribbons having 4 fibers per ribbon) may be positioned within a tube 5. The layer of yarn 3 may surround all tubes 5 as shown in FIG. 6. Alternatively, the layer of yarn 3 may surround each tube 5 as shown in FIG. 7.

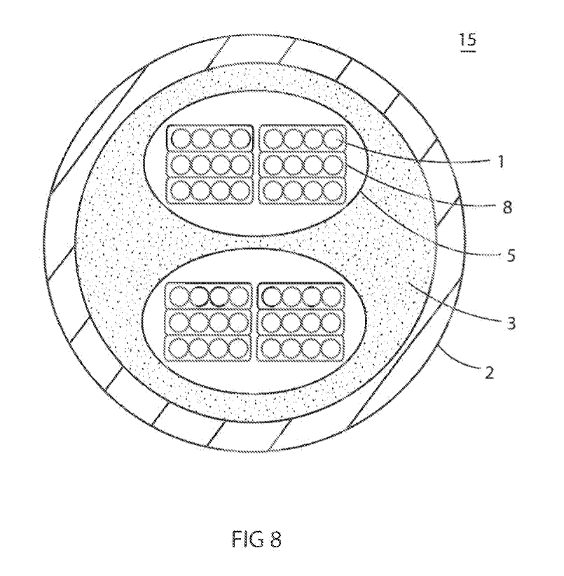

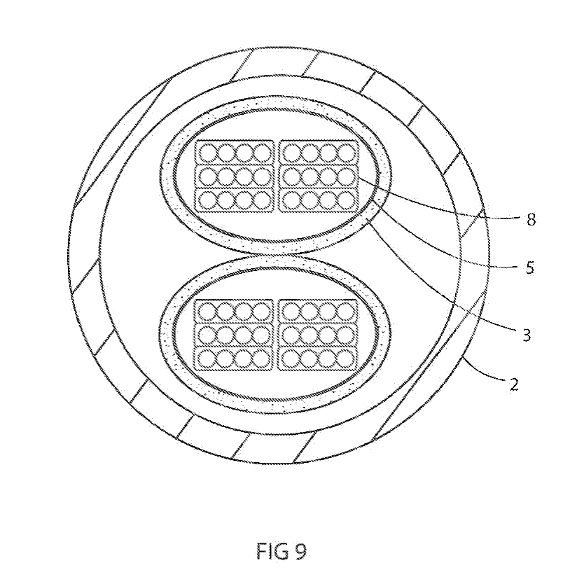

More than one optical fiber ribbons or array of optical fibers may be positioned within a tube 5. Referring to FIG. 8, for example, in a 48-fiber cable 15, two 3×4 array 8 of optical fibers 1 (i.e. 3 ribbons having 4 fibers per ribbon) arc positioned in a tube 5 together. The layer of yarn 3 may surround all tubes 5 as shown in FIG. 8. Alternatively, the layer of yarn 3 may surround each tube 5 as shown in FIG. 9.

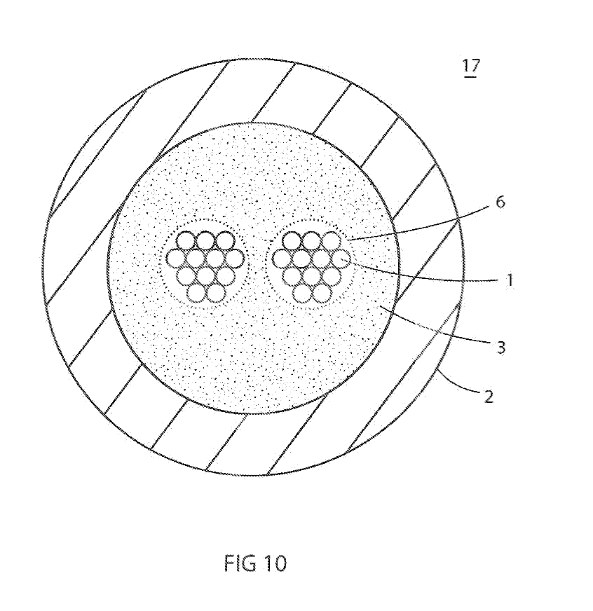

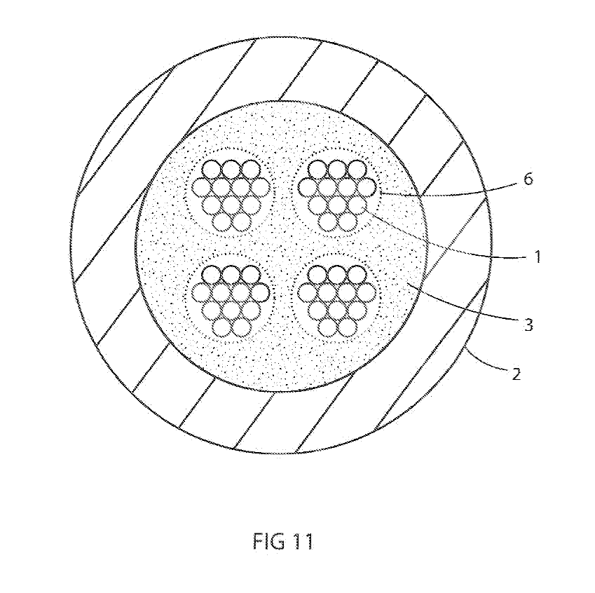

Referring to FIG. 10, a plenum-rated optical fiber cable 17 according to another embodiment of the invention is shown. The plenum-rated optical fiber cable 17 includes a plurality of the optical fibers 1, the jacket 2 surrounding the optical fibers 1, and the layer of yarn 3 positioned between the optical fibers 1 and the jacket 2. The plurality of the optical fibers 1 are arranged loosely together to form two optical fiber bundles 6. The bundles arc usually used for identification when more than 12 fibers are included in a cable. For example, in a 24-fiber cable, 1-12 fibers may be wrapped by one or more blue threads; 13-24 fibers may be the same combination of colors as 1-12, but are wrapped by an orange bundle thread for identification. If 12 or less fibers arc in the cable, a thread may not be needed. Another example of multiple optical fiber bundles 6 with different threads is shown in FIG. 11. However, the number of optical fibers in an optical fiber bundle may vary, and it depends on factors such as cable configuration, cable specification, and application of the cable.

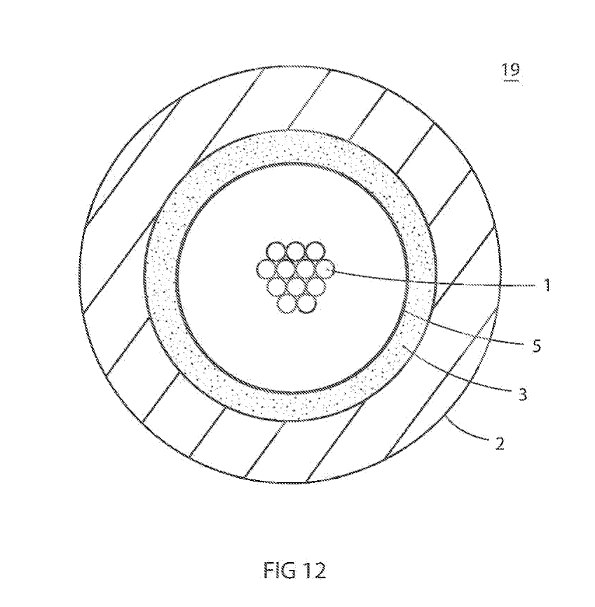

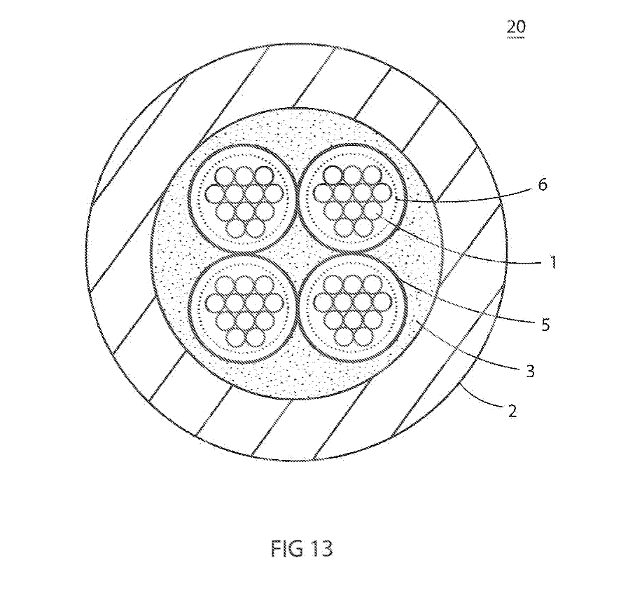

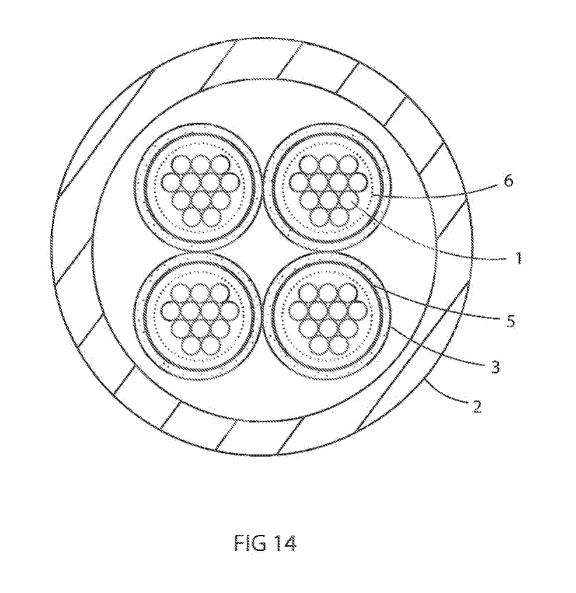

Referring to FIG. 12, a plenum-rated optical fiber cable 19 according to another embodiment of the invention is shown. The plenum-rated optical fiber cable 19 includes a plurality of the optical fibers 1, a tube 5 surrounding the optical fibers 1, the jacket 2 surrounding the tube 5, and the layer of yarn 3 positioned between the tube 5 and the jacket 2. In this embodiment, 12 optical fibers 1 are shown. However, the number of optical fibers in a tube may vary, and it depends on factors such as cable configuration, cable specification, the dimensions of the tube, and application of the cable. For example, in a 48-fiber cable 20 shown in FIG. 13, 1-12 fibers 1 may be wrapped by one or more threads 6 in one color (for example blue); 13-24 fibers 1 may be the same combination of colors as 1-12, but may be wrapped by an orange bundle thread for identification, and so on for 25-36 fibers, and 37-48 fibers. Each optical fiber bundle 6 may have a tube 5 as shown in FIG. 13. The layer of yarn 3 may surround all tubes 5 as shown in FIG. 13. Alternatively, the layer of yarn 3 may surround each tube 5 as shown in FIG. 14. The tube 5 can be any suitable material. For example a low-smoke polymer such as a low smoke INC or a fluoropolymer may be used as a tube material.

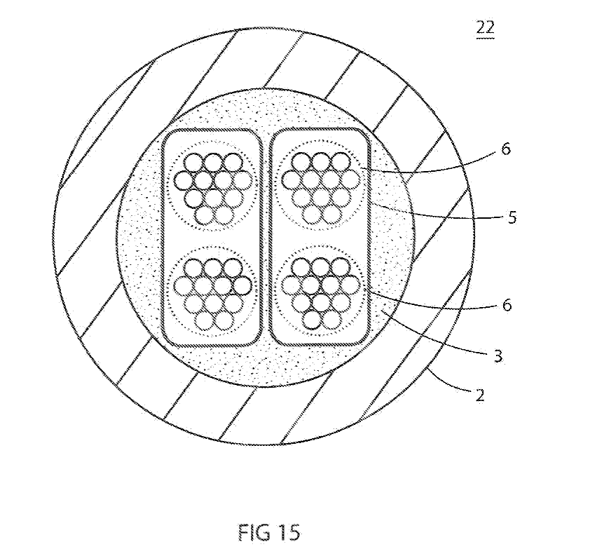

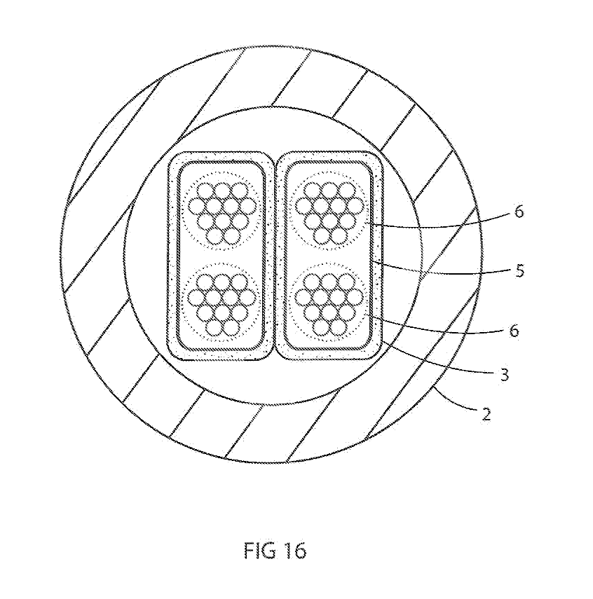

More than one fiber bundles 6 may be positioned within a tube 5. Referring to FIG. 15, for example, in a 48-fiber cable 22, two 12-fiber bundles 6 are in a tube 5. The layer of yarn 3 may surround all tubes 5 as shown in FIG. 15. Alternatively, the layer of yarn 3 may surround each tube 5 as shown in FIG. 16.

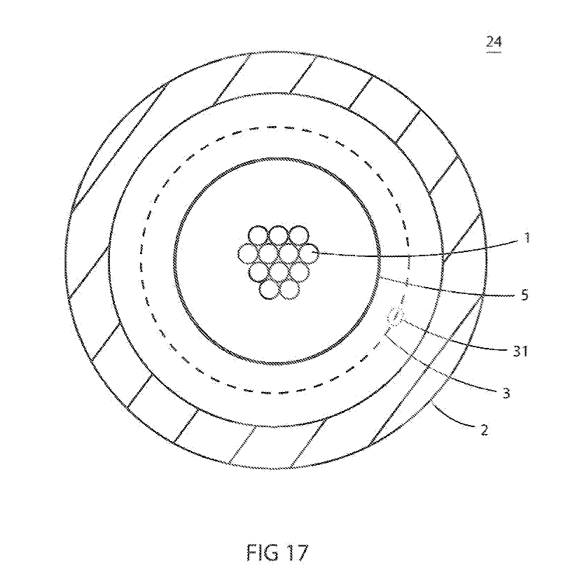

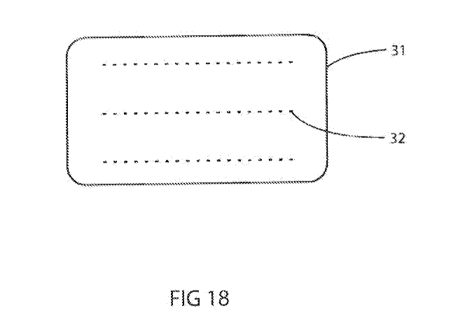

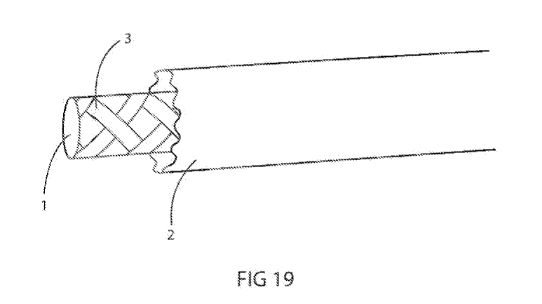

Referring to FIG. 17, a plenum-rated optical fiber cable 24 according to another embodiment of the invention is shown. The plenum-rated optical fiber cable 24 includes a plurality of the optical fibers 1, a tube 5 surrounding the optical fibers 1, the jacket 2 surrounding the tube 5, and the layer of yarn 3 positioned between the tube 5 and the jacket 2. In this embodiment, the layer of the yarn 3 comprises a plurality of yarn bundles 31 surround the tube 5. As shown in FIG. 18, the yarn bundle 31 includes plurality of yarn 32. Number of yarn 32 per a yarn bundle 31 depends on the parameters such as required tensile strength, cable diameter, and cable configuration. In all of the embodiments of the present invention, sufficient amount of yarn is positioned between the optical fiber and the jacket to provide tensile strength required for the resulting cable. If the layer of the yarn 3 is provided in the form of the yarn bundles 31, sufficient numbers of the yarn bundles 31 are positioned between the optical fiber and the jacket to provide tensile strength required for the application of the resulting cable. Referring back to FIG. 17, the cable 24 includes the tube 5 and plurality of optical fibers 1. However, the yarn bundles 31 may be used in cables without the tube 5, in cables having one or more optical fibers, in cables having one or more optical fiber ribbons, in cables having one or more optical fiber bundles, or in cables having buffered or unbuffered optical fibers. Furthermore, referring to FIG. 19, the layer of yarn 3, (or the yarn bundles 31 or the yarn 32) may position helically between the optical fiber 1 and the jacket 2.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples arc intended to be within the scope of the claims if they have structural elements that do not differ from the literal language of the claims, or if they include equivalent structural elements with insubstantial differences from the literal language of the claims.

What is claimed is:

1. A flame- and smoke-retardant optical fiber cable comprising:
an optical fiber;
a jacket surrounding the optical fiber comprising a low-smoke polymer; and
a layer of yarn positioned between the optical fiber and the jacket, wherein the yarn is coated with a sufficient amount of flame-retarding and smoke-suppressing material such that the cable passes the NFPA 262 “Steiner Tunnel” fire test, whereby its flame spread is less than 5 feet, peak optical density is less than 0.50, and average optical density is less than 0.15.

2. The flame- and smoke-retardant optical cable of claim 1, wherein the optical fiber is an unbuffered optical fiber.

3. The flame- and smoke-retardant optical cable of claim 1, wherein the optical fiber is a buffered optical fiber.

4. The flame- and smoke-retardant optical cable of claim 1, wherein a plurality of the optical fibers are bound together as one planar optical fiber ribbon.

5. The flame- and smoke-retardant optical cable of claim 4, wherein a plurality of the optical fiber ribbons stack on top of each other in a tube.

6. The flame- and smoke-retardant optical cable of claim 4, wherein a plurality of the optical fiber ribbons arc positioned within one or more tubes.

7. The flame- and smoke-retardant optical cable of claim 1, wherein a plurality of the optical fibers are arranged loosely together as one or more optical fiber bundles.

8. The flame- and smoke-retardant optical cable of claim 7, wherein the optical fiber bundle is positioned within a tube.

9. The flame- and smoke-retardant optical cable of claim 7, wherein a plurality of the optical fiber bundles are positioned within one or more tubes.

10. The flame- and smoke-retardant optical cable of claim 1, wherein the jacket comprises a fluoropolymer.

11. The flame- and smoke-retardant optical cable of claim 10, wherein the fluoropolymer is polyvinylidene fluoride (PVDF) copolymer.

12. The flame- and smoke-retardant optical cable of claim 1, wherein the jacket comprises low smoke PVC.

13. The optical fiber cable of claim 1, wherein the layer of yarn comprises a plurality of yarn bundles surrounding the optical fiber.

14. The optical fiber cable of claim 13, wherein a plurality of the yarn are arranged together as the yarn bundle.

15. The optical fiber cable of claim 1, wherein a sufficient amount of yarn is positioned between the optical fiber and the jacket such that the cable satisfies required tensile strength for its application.

16. The optical fiber cable of claim 1, wherein the yarn is an aramid yarn.

17. The optical fiber cable of claim 1, wherein the yarn positioned helically between the fiber and the jacket.

18. The optical fiber cable of claim 1, wherein the flame-retarding and smoke-suppressing material has intumescent properties such that the coating material creates an expanding char on the coated yarn surface to suppress both flame and smoke when subjected to high heat.

19. The optical fiber cable of claim 18, wherein the yarn is flame-retarding and smoke-suppressing coated yarn K1420/1765, which is commercially available from Fiber-Line, Inc.

20. The optical fiber cable of claim 1, wherein a nominal diameter of the cable is less than 10 mm for the cable having 72 fibers or less.

21. The optical fiber cable of claim 1, wherein a nominal diameter of the cable is less than 11 mm for the cable having 96 fibers or less.

22. A flame- and smoke-retardant optical fiber cable comprising:
an optical fiber;
a jacket surrounding the optical fiber comprising a low-smoke polymer; and
a layer of yarn positioned between the optical fiber and the jacket, wherein the yarn is coated with a sufficient amount of flame-retarding and smoke-suppressing material such that the total smoke of the layer of yarn is less than 100 according to cone calorimetry test.
